(19) United States
(12) Patent Application Publication
(10) Pub. No.: US 2013/0304962 A1
(43) Pub. Date: Nov. 14, 2013

(54) FIRMWARE CLEANUP DEVICE

(71) Applicants: HONG FU JIN PRECISION INDUSTRY (ShenZhen) CO., LTD., (US); HON HAI PRECISION INDUSTRY CO., LTD., New Taipei (TW)

(72) Inventors: Xiao-Gang YIN, Shenzhen (CN); Wan-Hong ZHANG, Shenzhen (CN)

(73) Assignees: HON HAI PRECISION INDUSTRY CO., LTD., New Taipei (TW); HONG FU JIN PRECISION INDUSTRY (ShenZhen) CO., LTD, Shenzhen (CN)

(21) Appl. No.: 13/858,095

(22) Filed: Apr. 8, 2013

(30) Foreign Application Priority Data
May 10, 2012 (CN) 201210143476.1

(51) Int. Cl. G06F 12/02

(52) U.S. Cl. CPC G06F 12/0246
USPC 711/102

(57) ABSTRACT

A firmware cleanup device includes a solid state disk (SSD) and an operation member. The SSD includes two pads and a connection portion, the connection portion defines two contacting pins respectively and electronically connected to the two pads. The operation member is detachably connected to the connection portion, the operation member includes two interconnected connection lines, and the two connection lines are respectively and electronically connected to the two contacting pins.

### BACKGROUND

1. Technical field

The disclosure generally relates to cleanup devices for computer programs, and particularly to a firmware cleanup device.

2. Description of the Related Art

Many electronic devices, such as servers, employ at least one solid state disk (SSD). To activate the SSD, firmware is written in the SSD. If the firmware is in an error state, two pads located on the SSD must be interconnected to force download of or removal of the firmware. However, due to the special location of the two pads, it may be inconvenient for an operator to have to use probes to interconnect the two pads.

Therefore, there is room for improvement within the art.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the present embodiments.

FIG. 1 is a planar view of a solid state disk of a firmware cleanup device, according to an exemplary embodiment.

FIG. 2 is similar to FIG. 1, showing another aspect.

FIG. 3 is a planar view of an operation member of the firmware cleanup device, according to an exemplary embodiment.

### DETAILED DESCRIPTION

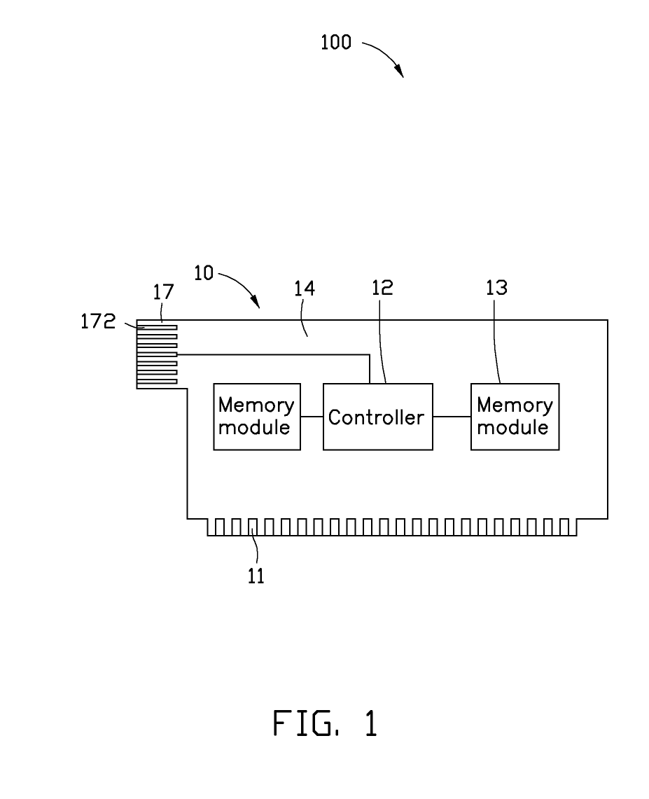

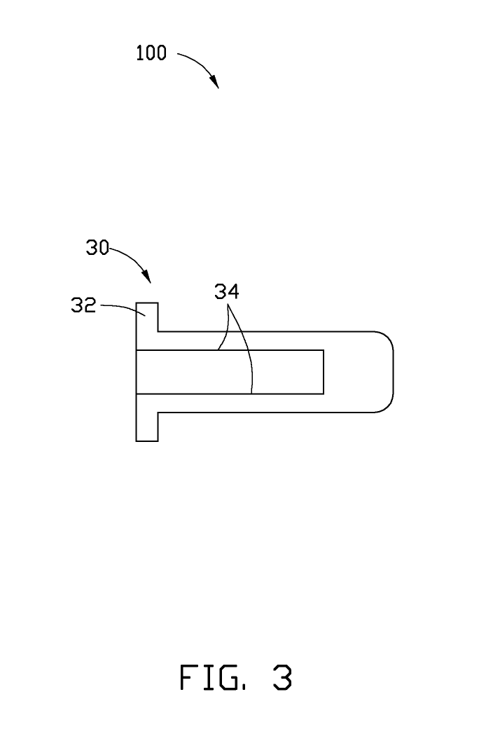

FIG. 1 and FIG. 3 show a firmware cleanup device 100 of an embodiment. The firmware cleanup device 100 includes a solid state disk (SSD) 10 and an operation member 30. The operation member 30 is detachably connected to the SSD 10, to cooperatively force download of or remove of firmware pre-written in the SSD 10.

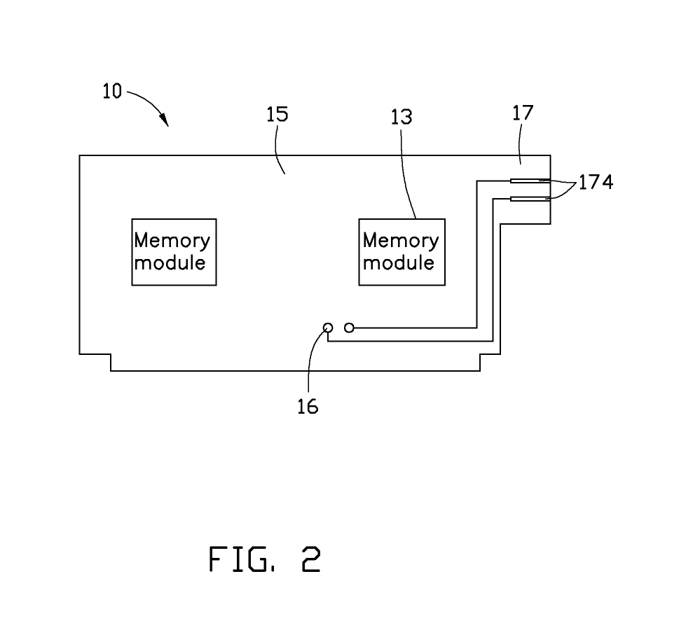

FIGS. 1-2 show that the SSD 10 integrates a connector 11, a controller 12, and a plurality of memory modules 13. The connector 11 is located at a side of the SSD 10, and is configured to be inserted into dual-inline-memory-modules (DIMM) of a motherboard of an electronic device, such as a personal computer, for example. The controller 12 is electronically connected to the connector 11, and the firmware is stored in the controller 12. The controller 12 is used to read data from an external device (for example, a personal computer or a mobile phone) by executing the firmware. The memory modules 13 are electronically connected to the controller 12 to store the data read by the controller 12.

The SSD 10 further includes a first surface 14 and a second surface 15 opposite to the first surface 14. In one exemplary embodiment, the connector 11 and the controller 12 are positioned on the first surface 14, the memory modules 13 are positioned on both of the first surface 14 and the second surface 15. The second surface 15 further defines two pads 16 electronically connected to the controller 12. When the two pads 16 are interconnected, the firmware can be force downloaded/removed from the controller 12.

The SSD 10 further includes a connection portion 17. The connection portion 17 is located at an end of the SSD 10, and includes a top surface (not labeled) and a bottom surface (not labeled). The top surface is coplanar with the first surface 14, and defines a plurality of connection pins 172. The bottom surface is coplanar with the second surface 15, and defines two contacting pins 174. The connection pins 172 are electronically connected to the controller 12, and are configured to be electronically connected to the motherboard of the electronic device via a common hard disk drive (HDD) cable, thus, the SSD 10 can communicate with the electronic device. The two contacting pins 174 are electronically connected to the two pads 16, respectively.

FIG. 3 shows that the operation member 30 includes a port 32 and two connection lines 34, where the port 32 receives the connection portion 17. The two connection lines 34 are interconnected, and respectively correspond to the two contacting pins 174. Thus, when the connection portion 17 is inserted into the port 32, the two contacting pins 174 are interconnected. In one exemplary embodiment, the common HDD cable can be served as the operation member 30, and two signals lines of the common HDD cable corresponding to the two contacting pins 174 are interconnected.

To activate the SSD 10, the firmware is written in the controller 12 via the motherboard and the connector 11. If the firmware has an error, the operation member 30 can be manipulated (e.g., by manual operation) to allow the connection portion 17 to be received in the port 32. Thus, the two connection lines 34 are respectively and electronically connected to the two contacting pins 174, and then the two pads 16 connected to the two contacting pins 174 are interconnected. Thus, the firmware stored in the controller 12 can be force downloaded or removed.

When firmware is completely force downloaded/removed from the controller 12, the operation member 30 is detached from the SSD 10, and new firmware may be written in the controller 12 to activate the SSD 10. Then, the motherboard of the electronic device is connected to the connection pins 172 of the connection portion 17 via a common HDD cable, and thus the SSD 10 can read data from the electronic device. Since the connection pins 172 and the contacting pins 174 are located at the two opposite surfaces of the connection portion 17, the connection pins 172 and the contacting pins 174 do not interfere with each other.

In summary, the SSD 10 includes two contacting pins 174 respectively and electronically connected to the two pads 16. When the operation member 30 is connected to the connection portion 17, the two pads 16 are interconnected to force download of or remove of the firmware. Therefore, the firmware cleanup device 100 is convenient because no probes are used.

Although numerous characteristics and advantages of the exemplary embodiments have been set forth in the foregoing description, together with details of the structures and functions of the exemplary embodiments, the disclosure is illustrative only, and changes may be made in detail, especially in the matters of arrangement of parts within the principles of disclosure to the full extent indicated by the broad general meaning of the terms in which the appended claims are expressed.

What is claimed is:

1. A firmware cleanup device, comprising:
a solid state disk (SSD) comprising two pads and a connection portion, the connection portion defining two contacting pins respectively and electronically connected to the two pads; and
an operation member detachably connected to the connection portion, the operation member including two interconnected connection lines, the two connection lines configured to be respectively and electronically connected to the two contacting pins.

2. The firmware cleanup device as claimed in claim 1, wherein the SSD further includes a controller electronically connected to the two pads, the controller stores firmware, when the two pads are interconnected, the firmware is force downloaded/removed from the controller.

3. The firmware cleanup device as claimed in claim 1, wherein the connection portion further includes a plurality of connection pins electronically connected to the controller.

4. The firmware cleanup device as claimed in claim 3, wherein the SSD includes a first surface and a second surface, the connection portion includes a top surface coplanar with the first surface and a bottom surface coplanar with the second surface, the connection pins are positioned at the top surface, and the contacting pins are positioned at the bottom surface.

5. The firmware cleanup device as claimed in claim 4, wherein the two pads are positioned at the second surface.

6. The firmware cleanup device as claimed in claim 1, wherein the operation member further includes a port to receive the connection portion.

7. A firmware cleanup device, comprising:
an operation member; and
a solid state disk (SSD), the SSD comprising:
a controller storing firmware;
two pads electronically connected to the controller; and
two contacting pins respectively and electronically connected to the two pads;
wherein manipulation of the operation member causes the SSD to be electronically connected to the operation member, and the two pads are interconnected to force download of or remove of the firmware.

8. The firmware cleanup device as claimed in claim 7, wherein the SSD further includes a connection portion; the two contacting pins are positioned at the connection portion.

9. The firmware cleanup device as claimed in claim 8, wherein the operation member includes a port to receive the connection portion.

10. The firmware cleanup device as claimed in claim 9, wherein the operation member further includes two interconnected connection lines, the two connection lines are respectively and electronically connect to the two contacting pins.

11. The firmware cleanup device as claimed in claim 8, wherein the connection portion further includes a plurality of connection pins electronically connected to the controller.

12. The firmware cleanup device as claimed in claim 11, wherein the SSD includes a first surface and a second surface, the connection portion includes a top surface coplanar with the first surface and a bottom surface coplanar with the second surface, the connection pins are positioned at the top surface, and the contacting pins are positioned at the bottom surface.

13. The firmware cleanup device as claimed in claim 12, wherein the two pads are positioned at the second surface.
